(19) United States
(12) Patent Application Publication
(10) Pub. No.: US 2004/0200631 A1
(43) Pub. Date: Oct. 14, 2004

(54) CABLE AND CONNECTION MODULE FOR A UNIVERSAL SERIAL BUS INTERFACE

(76) Inventor: Lei Chen, Su-Chou City (CN)

Correspondence Address: NAIPO (NORTH AMERICA INTERNATIONAL PATENT OFFICE), P.O. BOX 506, MERRIFIELD, VA, 22116, US

(21) Appl. No.: 10/709,028

(22) Filed: Apr. 8, 2004

(30) Foreign Application Priority Data
Apr. 10, 2003 (TW) 092108279

(51) Int. Cl. H01B 7/29

(52) U.S. Cl. 174/36

(57) ABSTRACT

A cable for a universal serial bus (USB) interface includes a host connection end located on one side of the cable including two power pins and two signal pins, a data connection end located on another side of the cable including two signal pins, and at least one power connection end located on the same side as the data connection end of the cable including only two power pins. A connection module for connecting the cable includes a housing, a host connection port including two signal pins and two power pins, a data connection port including two signal pins connected to the two signal pins of the host connection port respectively, and at least one power connection port including only two power pins connected to the two power pins of the host connection port respectively.

### BACKGROUND OF INVENTION

1. Field of the Invention

The present invention relates to a cable and a connection module, and more particularly, to a cable and a connection module for universal serial bus (USB) interface.

2. Description of the Prior Art

The universal serial bus (USB) interface is a convenient and low-cost connection. The USB interface is capable of connecting a plurality of peripheral devices to a computer including printers, game pads, keyboards, mice, scanners, modems, digital cameras, and portable disks. The USB interface supports hot plugging and plug and play, so users do not need to turn off the power or reset the computer to add or remove peripheral devices and do not need to worry about resource conflicts in the computer. When a peripheral device is connected to the computer, the computer will detect and install correct driver for peripheral device. Peripheral devices do not need to connect to the computer directly and can be connected to the computer in any order. For example, users can connect a keyboard and a printer to the computer, then connect a mouse and a game pad to the keyboard, and connect a modem and a scanner to the computer via the printer. In addition, the USB interface further includes advantages of ease in expansion, ease in installation, and fast transmission, so it is welcome in the market.

Please refer to FIG. 1. FIG. 1 is a view of a USB cable 10 according to the prior art. The cable 10 comprises a host connection end 12 and a peripheral device connection end 14. According to the USB standard, the USB interface transmits data according to a communication protocol and uses time division multiplexing in each peripheral device. The cable 10 comprises four pins wherein two signal pins (D+ and D−) transmit a differential signal and two power pins (VCC and GND) provide 5V/500 mA source power. The power management of the USB interface can be divided into self power and bus power. Self power requires a peripheral device to provide power itself. Take a four-port hub for example, where each port can provide 500 mA current. Bus power is further divided into high power and low power. Low power provides for power consumption of the peripheral device under 100 mA, and high power provides for power consumption of the peripheral under 500 mA. Take another four-port hub for example, where each port can provide 100 mA current and the hub consumes 100 mA itself so the total is 500 mA. If the power consumption of the peripheral device is over 500 mA, it violates the USB standard and results in incompatibility.

The above-mentioned USB interface not only provides data transmission between the peripheral device and the computer but also provides power to the peripheral device. However, many peripheral devices only use the USB interface to transmit data and use an independent power source. Such type of devices includes scanners, printers, and modems. On the other hand, some peripheral devices only use the USB interface to provide a power source and do not require communication of data. This type of devices includes chargers, heaters, and radiators. Therefore, some peripheral devices do not use all resources of the USB interface provided resulting in a waste of resources. Moreover, each peripheral device occupies one USB port, however, a computer only provides a limited number of ports, and a user has to buy a hub if they want to expand the number of ports.

### SUMMARY OF INVENTION

It is therefore a primary objective of the claimed invention to provide a cable and a connection module for a USB interface to solve the above-mentioned problems.

According to the claimed invention, a cable for a universal serial bus (USB) interface comprises: a host connection end installed on one end of the cable comprising two power pins and two signal pins for connecting to a USB port of a computer; a data connection end installed on another end of the cable comprising two signal pins connected to the two signal pins of the host connection end respectively for connecting to a USB port of a first peripheral device and providing communication between the first peripheral device and the computer; and at least one power connection end installed on the same end of the cable as the data connection end comprising only two power pins for connecting to a USB port of a second peripheral device and providing power to the second peripheral device.

The invention further provides a connection module for a universal serial bus (USB) interface comprising: a housing; a host connection port installed on the housing comprising two power pins and two signal pins for providing connection to a computer; a data connection port installed on the housing comprising two signal pins connected to the two signal pins of the host connection port respectively for providing connection to the first peripheral device so that the computer communicates with the first peripheral device; and at least one power connection port installed on the housing comprising only two power pins connected to the two power pins of the host connection port for providing connection to the second peripheral device so that the computer transmits power to the second peripheral device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a view of an USB cable according to the prior art.

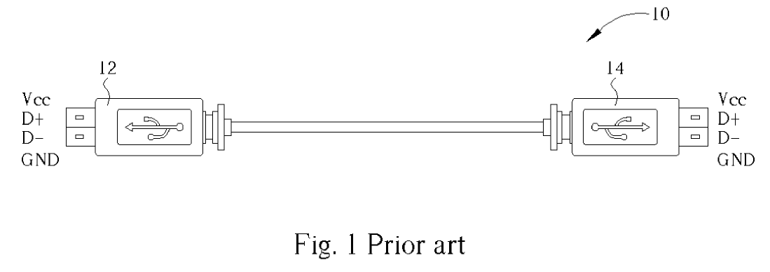

FIG. 2 is a view of a first USB cable according to the present invention.

FIG. 3 is a view of a second USB cable according to the present invention.

FIG. 4 is a view of a third USB cable according to the present invention.

FIG. 5 is a view of a fourth USB cable according to the present invention.

FIG. 6 is a view of a USB connection module according to the present invention.

### DETAILED DESCRIPTION

The present invention relates to the universal serial bus (USB) interface. Currently, USB devices according to USB 1.1 and 2.0 specifications are in wide use, however, the present invention also applies to earlier or forthcoming versions of USB, and generally, to interfaces that are similar to USB.

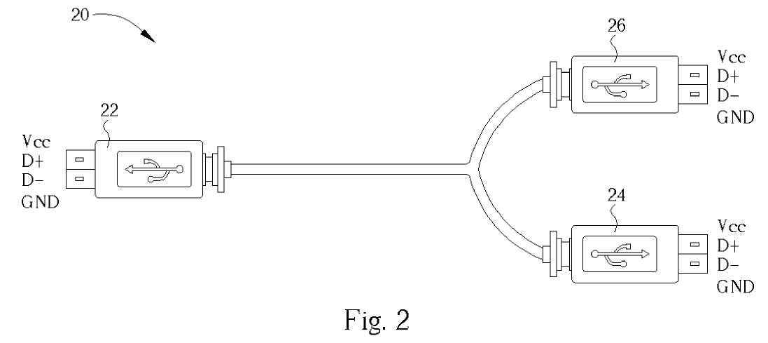

Please refer to FIG. 2. FIG. 2 is a view of a first USB cable 20 according to the present invention. The cable 20 comprises a host connection end 22, a data connection end 24, and a power connection end 26. The host connection end 22 installed on one end of the cable 20 for connecting a USB port of a computer comprises two power pins and two signal pins. The data connection end 24 installed on another end of the cable 20 comprises two power pins and two signal pins connected to the two power pins and the two signal pins of the host connection end 22 respectively. The power connection end 26 installed on the same end as the data connection end 24 comprises two power pins and two signal pins connected to the two power pins and the two signal pins of the host connection end 22 respectively. The data connection end 24 connects to a USB port of a first peripheral device and provides signal communication between the first peripheral device and the computer. The power connection end 26 connects to a USB port of a second peripheral device and provides power source of the second peripheral device. In order to decrease the number of the USB ports, the cable 20 according to the present invention divides the peripheral device connection end 14 of the cable 10 according to the prior art into the data connection end 24 and the power connection end 26. In this way, one cable can connect to two peripheral devices at the same time. However, there are some limitations in the peripheral device. First peripheral devices connected to the data connection end 24 can only use the cable 20 to transmit data. These devices include scanners, printers, and modems, and other devices that do not require USB power. Second peripheral devices connected to the power connection end 26 can only use the cable 20 as a power source. These devices include lights, chargers, heaters, and radiators, and other devices that do not require USB communication capability. First peripheral device only use the signal pins of the cable 20 to transmit data and second peripheral devices only use the power pins of the cable 20 to provide power, so the first and the second peripheral devices can work normally. In the following, the cable 20 is improved to prevent a user connecting two first peripheral devices to the data connection end 24 and the power end 26 resulting in the computer crashing and the peripheral devices failing.

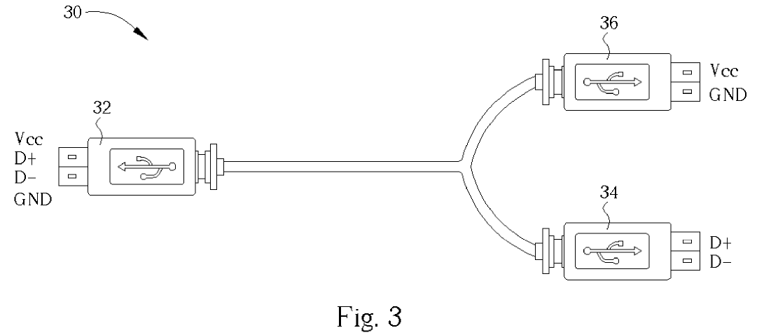

Please refer to FIG. 3. FIG. 3 is a view of a second USB cable 30 according to the present invention. The cable 30 comprises a host connection end 32, a data connection end 34, and a power connection end 36. Since the first peripheral devices use only two data pins to transmit data and the second peripheral devices use only two power pins to provide power, two power pins are removed from the data connection end and two signal pins are removed from the power connection end to produce the second cable 30. In this way, even if a user connects first peripheral devices to the data connection end 24 and the power connection end 26 at the same time, the computer and the peripheral device can work normally. However, if the user wants to connect some peripheral device that uses the USB interface to transmit data and provide power such as a keyboard, mouse, or digital camera, the cable 30 cannot be used. For this reason, the preferred embodiment according to present invention is as follows.

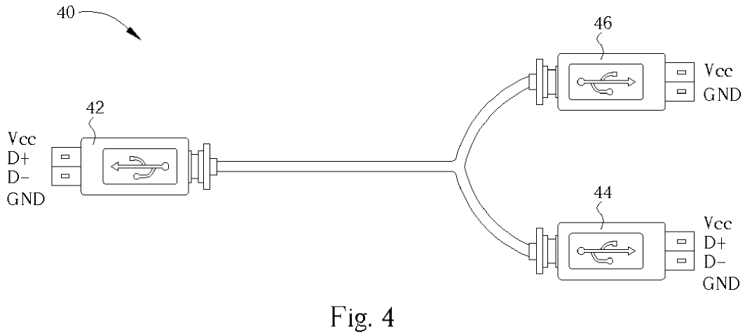

Please refer to FIG. 4. FIG. 4 is a view of a third USB cable 40. The cable 40 comprises a host connection end 42, a data connection end 44, and a power connection end 46. The cable 40 not only can prevent a user from connecting first peripheral devices to the data connection end and the power connection end at the same time but also can maintain the cable 40 for general use. The data connection end 44 of the cable 40 comprises two signal pins and two power pins, and the power connection end 46 of the cable 40 comprises only two power pins. Users can connect all kinds of peripheral devices with the data connection end 44 of the cable 40 no matter if peripheral device is a first peripheral device that uses the signal pins of the cable 40 to transmit data, a second peripheral device that uses the power pins of the cable 40 for power, or a peripheral device that uses the cable 40 to transmit data and provide power at the same time. Therefore, the data connection end 44 of the cable 40 provides general use compatibility. The power connection end 46 comprises only two power pins so it only can be used for providing a power source. If a user connects two first peripheral devices to the data connection end 44 and the power connection end 46 at the same time, then only the peripheral device connected to the data connection end 44 will work, while the peripheral device connected to the power connection end 44 will not work. Therefore, the cable 40 can prevent the computer from crashing and the peripheral devices from failing. If a user connects two second peripheral devices to the power connection end 46 at the same time, then the two peripheral devices can work normally as long as the total current is under 500 mA.

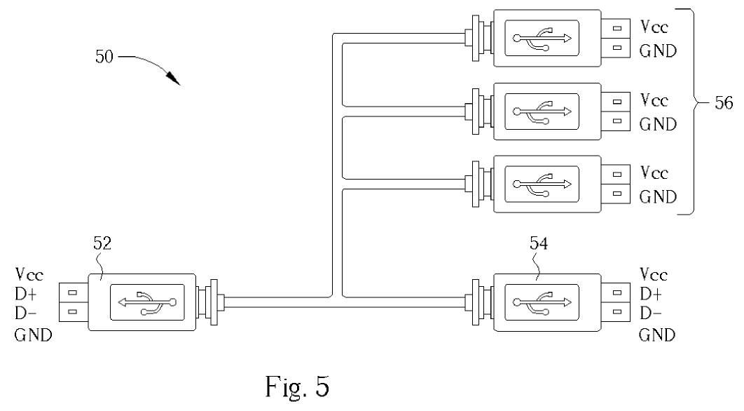

Please refer to FIG. 5. FIG. 5 is a view of a fourth USB cable 50. The cable 50 comprises a host connection end 52, a data connection end 54, and three power connection ends 56. In this embodiment, when the data connection end 54 and the power connection end 56 of the cable 50 are connected to second peripheral devices, the peripheral devices can work normally as long as the current is under 500 mA according to the USB standard. In this embodiment, the power connection ends of the cable 50 are increased to three, as shown in FIG. 5. Three power connection ends can connect to three second peripheral devices as long as the total current is under 500 mA and the peripheral devices can work normally.

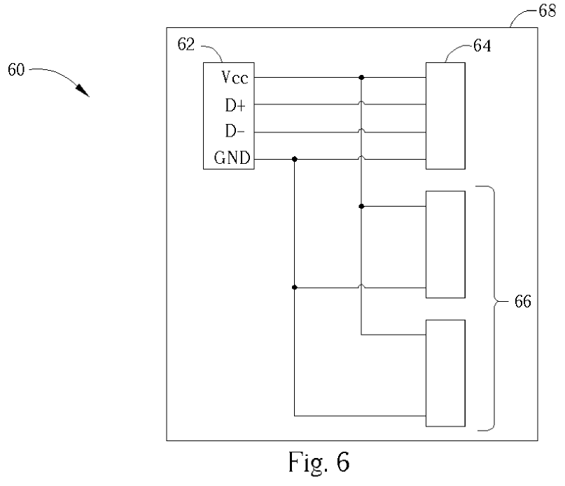

Please refer to FIG. 6. FIG. 6 is a view of a connection module 60 according to the present invention. The connection module 60 comprises a housing 68, a host connection port 62, a data connection port 64, and two power connection ports 66 installed on the housing 68 respectively. The host connection port 62 comprises two signal pins and two power pins. The host connection port 62 is capable of connecting to a USB port of a computer via a USB cable. The data connection port 64 comprises two signal pins and two power pins connected to the two signal pins and the two power pins of the host connection port 62 respectively. The data connection port 64 is capable of connecting to a USB port of any peripheral device via a USB cable so that the computer can transmit signals and powers to the peripheral device. The power connection port 66 comprises only two power pins connected to the two power pins of the host connection port 62 respectively. The power connection port 66 is capable of connecting to a USB port of the second peripheral device so that the computer can transmit powers to the second peripheral device. With the connection module 60, users need only one USB port of the computer to connect one any peripheral device and two second peripheral devices at the same time. In addition, the number of power connection ports 66 can be increased as necessary, and only if the total current of the peripheral devices connected to the power connection ports 66 is under 500 mA, the standard of USB. Thus, all peripheral devices can work normally.

From the above-mentioned, the cable 40 and connection module 60 expand the use of USB port in the form of the cable (plug) and the connection port (socket) respectively so that every USB port can be fully utilized. After connecting the cable 40 or the connection module 60, a USB port can connect to one of any type of peripheral device and at least one second peripheral device.

In contrast to the prior art, the present invention divides the peripheral device connection end of the USB cable according to the prior art into a data connection end and at least one power connection end. The data connection end comprises two signal pins and two power pins for connecting all kinds of peripheral devices so as to maintain the cable for general use. The power connection end comprises only two power pins for connecting to a second peripheral device. The number of the power connection ends can be increased according to the requirements of users only if the current conforms to the USB standard. In addition, the present invention further provides a connection module comprising a host connection port, a data connection port, and at least one power connection port. The data connection port comprises two signal pins and two power pins for connecting all kinds of peripheral devices so as to maintain compatibility for general use. The power connection port comprises only two power pins for connecting to a second peripheral device. Therefore, with the cable and the connection module according to the present invention, every USB port of the computer can be fully utilized. The cable according to the prior art uses one USB port for connecting one peripheral device, however, only some peripheral devices need to transmit data and power. In the present invention, the cable uses one USB port for connecting a plurality of peripheral devices, so that resources can be used more efficiently.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A cable for a universal serial bus (USB) interface comprising:
a host connection end installed on one end of the cable comprising two power pins and two signal pins for connecting to a USB port of a computer;
a data connection end installed on another end of the cable comprising two signal pins connected to the two signal pins of the host connection end respectively for connecting to a USB port of a first peripheral device and providing communication between the first peripheral device and the computer; and
at least one power connection end installed on the same end of the cable as the data connection end comprising only two power pins for connecting to a USB port of a second peripheral device and providing power to the second peripheral device.

2. The cable of claim 1 wherein the communication protocol of the signal pins conforms to USB 1.1/2.0 standard.

3. The cable of claim 1 wherein the power provided by the power pins conforms to USB 1.1/2.0 standard.

4. The cable of claim 1 wherein the materials of the cable conform to USB 1.1/2.0 standard.

5. The cable of claim 1 wherein the first peripheral device is a scanner, a printer, or a modem.

6. The cable of claim 1 wherein the second peripheral device is a light, a charger, or a radiator.

7. The cable of claim 1 wherein the data connection end further comprises two power pins connected to the two power pins of the host connection end for providing power to the first peripheral device.

8. The cable of claim 7 wherein the first peripheral device is a keyboard, a mouse, or a digital camera.

9. A connection module for a universal serial bus (USB) interface comprising:
a housing;
a host connection port installed on the housing comprising two power pins and two signal pins for providing connection to a computer;
a data connection port installed on the housing comprising two signal pins connected to the two signal pins of the host connection port respectively for providing connection to a first peripheral device so that the computer communicates with the first peripheral device; and
at least one power connection port installed on the housing comprising only two power pins connected to the two power pins of the host connection port for providing connection to a second peripheral device so that the computer transmits power to the second peripheral device.

10. The connection module of claim 9 wherein the data connection port further comprises two power pins connected to the two power pins of the host connection port so that the computer transmits power to the first peripheral device.

11. The connection module of claim 9 wherein the first peripheral device is a keyboard, a mouse, or a digital camera.

12. The connection module of claim 9 wherein the first peripheral device is a scanner, a printer, or a modem.

13. The connection module of claim 9 wherein the second peripheral device is a light, a charger, or a radiator.

14. The connection module of claim 9 wherein the communication protocol of the signal pins conforms to USB 1.1/2.0 standard.

15. The connection module of claim 9 wherein the power provided by the power pins conforms to USB 1.1/2.0 standard.
